(19) United States
(12) Patent Application Publication
(10) Pub. No.: US 2026/0128932 A1
(43) Pub. Date: May 7, 2026

(54) TRANSLATION DEVICE

(71) Applicant: Samsung Electronics Co., Ltd., Suwon-si (KR)

(72) Inventors: Jaehyun Baek, Suwon-si (KR); Hyoungwook Kim, Suwon-si (KR); Sungchul Chun, Suwon-si (KR)

(73) Assignee: Samsung Electronics Co., Ltd., Suwon-si (KR)

(21) Appl. No.: 19/246,085

(22) Filed: Jun. 23, 2025

(30) Foreign Application Priority Data
Nov. 7, 2024 (KR) 10-2024-0157144

(51) Int. Cl. H04L 25/49; H04L 7/00

(52) U.S. Cl. CPC H04L 25/4917; H04L 7/0016

(57) ABSTRACT

A translation device includes a first input/output circuit configured to transmit and receive a first signal having a first signal speed modulated based on a non-return to zero (NRZ) method through a plurality of first pins; a second input/output circuit configured to transmit and receive a second signal having a second signal speed modulated based on a pulse amplitude modulation-3 (PAM-3) method through a plurality of second pins; and a translation circuit configured to translate the first signal to the second signal, or translate the second signal to the first signal, wherein the second signal speed is equal to or greater than the first signal speed.

### CROSS-REFERENCE TO RELATED APPLICATIONS

This application claims benefit of priority to Korean Patent Application No. 10-2024-0157144, filed on Nov. 7, 2024 in the Korean Intellectual Property Office, the disclosure of which is incorporated herein by reference in its entirety.

### FIELD

Example embodiments of the present disclosure relate to a translation device.

### BACKGROUND

A memory device may receive a clock signal, a command/address signal, and a data signal from an external device. A multilevel signaling method may be required to improve efficiency of an input/output interface of a memory device. In this case, a method of improving efficiency of the input/output interface of the memory device based on a signal according to the pulse amplitude modulation-3 (PAM-3) method having three voltage levels may be suggested.

In mass production of a memory device, a memory device may be tested as a device under test (DUT). The test device may use non-return to zero (NRZ) having two voltage levels as an interface of a general digital circuit. Accordingly, in a test of a memory device based on a PAM-3 method, issues such as developing a new test device or replacing major components related to signal generation in an existing translation device may occur.

### SUMMARY

An example embodiment of the present disclosure is to provide a translation device which may translate different signal methods and signal speeds such that a test device using a low-speed NRZ interface may perform a test on a memory device using a high-speed PAM-3 interface.

According to an example embodiment of the present disclosure, a translation device includes a first input/output circuit configured to transmit and receive a first signal having a first signal speed modulated based on a non-return to zero (NRZ) method through a plurality of first pins; a second input/output circuit configured to transmit and receive a second signal having a second signal speed modulated based on a pulse amplitude modulation-3 (PAM-3) method through a plurality of second pins; and a translation circuit configured to translate the first signal to the second signal or translate the second signal to the first signal, wherein the second signal speed is equal to or greater than the first speed.

According to an example embodiment of the present disclosure, a translation device includes a first input/output circuit configured to transmit and receive a first signal having a first signal speed modulated based on a NRZ method, the first signal including a first clock signal, a first command/address signal, and a first data signal; a second input/output circuit configured to transmit and receive a second signal having a second signal speed modulated based on a PAM-3 method, the second signal including a second clock signal, a second command/address signal, and a second data signal; a phase locked loop (PLL) circuit configured to multiply the first clock signal and output the multiplied first clock signal; a command generator configured to output the first command/address signal as the second command/address signal according to the multiplied first clock signal; and a translation circuit configured to translate the first data signal to the second data signal or to translate the second signal to the first signal, wherein the second signal speed is equal to or greater than the first signal speed, and wherein the translation circuit is configured to translate at least two bits among a plurality of bits included in the first data signal to at least one symbol included in the second data signal, or translate at least one symbol among a plurality of symbols of the second signal to at least two bits of the first signal.

According to an example embodiment of the present disclosure, a translation device includes a first input/output circuit configured to transmit and receive a first clock signal, a first command/address signal, and a first data signal, wherein each of the first clock signal, the first command/address signal and the first data signal is a signal having a first signal speed modulated based on a NRZ method through a plurality of first pins; a second input/output circuit configured to transmit and receive a second clock signal, a second command/address signal, and a second data signal, wherein each of the second clock signal, the second command/address signal and the second data signal is a signal having a second signal speed modulated based on a PAM-3 method through a plurality of second pins; a translation circuit configured to translate the first data signal to the second data signal or translate the second data signal to the first data signal; a PLL circuit configured to multiply and output the first clock signal having the first signal speed; a command generator configured to output the first command/address signal as the second command/address signal according to a multiplied first clock signal; a mode register configured to store information about the first signal speed and the second signal speed; a first training circuit configured to control an input time of at least one of: the first data signal, the first clock signal, or the first command/address signal; and a second training circuit configured to control an input time of at least one of: the second data signal, the second clock signal, or the second command/address signal.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a block diagram illustrating a test system consistent with an example embodiment of the present disclosure.

FIG. 2 is a block diagram illustrating a test system consistent with an example embodiment of the present disclosure.

FIG. 3 is a flowchart illustrating operations of a test system consistent with an example embodiment of the present disclosure.

FIG. 4 is a graph illustrating a data eye indicating an NRZ method consistent with an example embodiment of the present disclosure.

FIG. 5 is a graph illustrating a data eye indicating a PAM-3 method consistent with an example embodiment of the present disclosure.

FIG. 6 is a block diagram illustrating a test system consistent with an example embodiment of the present disclosure.

FIG. 7A is a diagram illustrating a first signal of a test system consistent with an example embodiment of the present disclosure.

FIG. 7B is a diagram illustrating a second signal of a test system consistent with an example embodiment of the present disclosure.

FIG. 8 is a block diagram illustrating a test system consistent with an example embodiment of the present disclosure.

FIG. 9A is a diagram illustrating a first signal of a test system consistent with an example embodiment of the present disclosure.

FIG. 9B is a diagram illustrating a second signal of a test system consistent with an example embodiment of the present disclosure.

FIG. 10 is a block diagram illustrating a test system consistent with an example embodiment of the present disclosure.

FIG. 11A is a diagram illustrating a first signal of a test system consistent with an example embodiment of the present disclosure.

FIG. 11B is a diagram illustrating a second signal of a test system consistent with an example embodiment of the present disclosure.

FIG. 12 is a diagram illustrating a test system consistent with an example embodiment of the present disclosure.

FIG. 13A is a diagram illustrating a first signal of a test system consistent with an example embodiment of the present disclosure.

FIG. 13B is a diagram illustrating a second signal of a test system consistent with an example embodiment of the present disclosure.

### DETAILED DESCRIPTION

Hereinafter, embodiments of the present disclosure will be described as follows with reference to the accompanying drawings.

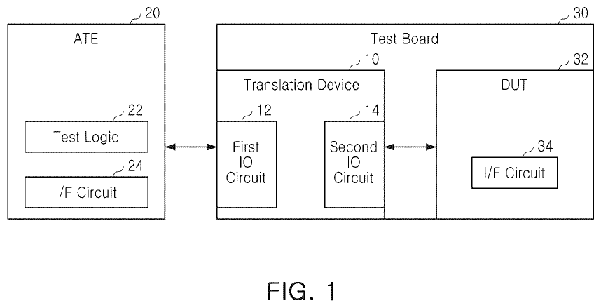

FIG. 1 is a block diagram illustrating a test system consistent with an example embodiment.

Referring to FIG. 1, a test system 1 for testing various types of semiconductor devices such as a memory device may include a test device (automatic test equipment, ATE) 20 and a test board 30 on which at least one device under test (DUT) 32 on which a test is performed is mounted.

The test device 20 and the device under test 32 may be disposed externally of the test board 30. The test device 20 and the device under test 32 may communicate with each other through the test board 30. For example, the device under test 32 may be physically connected to the test board 30 through a socket. The device under test 32 may communicate with the test device 20 through the test board 30.

The test board 30 may be referred to as an interface board on a side surface providing an interface between the test device 20 and the device under test 32. For example, the test board 30 may include a printed circuit board (PCB), and the printed circuit board may include a plurality of conductive lines for transferring electrical signals, and test signals from the test device 20 may be transferred to the device under test 32 through the plurality of conductive lines, or test results from the device under test 32 may be transferred to the test device 20 through the plurality of conductive lines. In an example embodiment, at least a portion of the plurality of conductive lines may be involved in signal transfer between the test device 20 and the device under test 32, and a component including the at least portion of the conductive lines may be an interconnection circuit.

The test device 20 may include a test logic 22 and an interface circuit 24. The test device 20 may further include various components, such as a communication device for communicating with an external host requesting a test, a memory (not shown) for temporarily storing various pieces of information related to various tests, and a power supply circuit (not shown) for providing power to the device under test 32.

According to an example embodiment, the test device 20 may include a semiconductor chip such as a field programmable gate array (FPGA), an application specific integrated circuit (ASIC), and an application processor (AP). As illustrated in FIG. 1, at least one device under test 32 may be mounted on the test board 30. For example, when the plurality of devices under tests 32 are mounted on the test board 30, test operations for the plurality of devices under tests 32 may be performed in parallel.

When a test is performed on one device under test 32, the test device 20 may simultaneously provide test signals to the device under test 32 through a plurality of channels, and may simultaneously receive test results from the device under test 32 through the plurality of channels.

The test process for determining whether a semiconductor device is defective may be performed in various operations of the semiconductor process, and may include a wafer level test and a post-wafer level test. The wafer level test may correspond to a test for individual semiconductor dies at the wafer level. Also, the test after the wafer level may correspond to a test for a semiconductor die before packaging is performed, or a test for a semiconductor package in which one semiconductor die (or semiconductor chip) is packaged. Alternatively, the test for a semiconductor package may correspond to a test for a semiconductor package including a plurality of semiconductor chips.

The device under test 32 may be configured as a variety of semiconductor devices, and may be configured as a memory device including a semiconductor memory cell array, for example. For example, the memory device may be a dynamic random access memory, such as double data rate synchronous dynamic random access memory (DDR SDRAM), low power double data rate (LPDDR) SDRAM, graphics double data rate (GDDR) SDRAM, and Rambus dynamic random access memory (RDRAM). Alternatively, the memory device may be a flash memory, magnetic RAM (MRAM), ferroelectric RAM (FeRAM), phase change RAM (PRAM) and resistive RAM (ReRAM).

The device under test 32 may include an interface circuit 34. The device under test 32 may receive test signals from the test device 20 through the interface circuit 34. Also, the device under test 32 may store data according to test signals received through the interface circuit 34 in the memory cell array (not shown). Also, the device under test 32 may read data stored in the memory cell array and may provide test results according to the read data to the test device 20 through the interface circuit 34.

According to an example embodiment, the device under test 32 may be a memory device interfacing a signal modulated based on a 3-level pulse amplitude modulation (hereinafter referred to as “pulse amplitude modulation (PAM)-3”) method. The PAM-3 method may be a modulation method for transmitting a plurality of bits during one unit interval, and the unit interval may correspond to a symbol period for transmitting a signal of one symbol. When data is modulated by the PAM-N method, one symbol may include more than one bit.

The test device 20 may include an interface circuit 24 interfacing a signal modulated based on a 2-level pulse amplitude modulation (hereinafter referred to as “non-return to zero (NRZ)”) method. The NRZ method may be a modulation method for transmitting one bit during one unit interval. When a signal is modulated with the NRZ method, one symbol may include one bit.

The test system 1 in an example embodiment may include a translation device 10 disposed between the test device 20 and the device under test 32. The translation device 10 may translate a signal modulated based on the NRZ method into a signal based on the PAM-3 method. Accordingly, a test for the device under test 32 based on the PAM-3 interface may be performed using the test device 20 based on the NRZ interface. As the example embodiment illustrated in FIG. 1, the translation device 10 may be disposed externally of the test board 30. The translation device 10 may be physically connected to the test board 30 through the socket.

The translation device 10 may include a first input/output circuit 12 and a second input/output circuit 14. The translation device 10 may transmit a signal to, and receive a signal from, the test device 20 through the first input/output circuit 12, and in this case, the signal may be based upon the NRZ method. The translation device 10 may transmit a signal to, and receive a signal from, the device under test 32 through the second input/output circuit 14, and in this case, the signal may be based upon the PAM-3 method.

As an example embodiment of a test operation, the test logic 22 of the test device 20 may generate data of a plurality of bits as a test pattern, and each bit may have a logic state according to a value thereof. The interface circuit 24 of the test device 20 may generate and output NRZ signals based on the logic state of a plurality of bits. The NRZ signals may be translated into PAM-3 signals by the translation device 10 and may be provided to the device under test 32.

One PAM-3 signal provided to the device under test 32 may include about 1.5 bits. The logic state of the PAM-3 signal may be determined through a demodulation process for the PAM-3 signal in the device under test 32. Data determined from each PAM signal may be written (programmed) to a memory cell array in the device under test 32.

The data written to the memory cell array may be read again. The read data may be translated into PAM-3 signals again through a demodulation process and may be transferred to the translation device 10 and/or the test device 20 through a channel of the device under test 32. Translation device 10 and/or the test device 20 may determine the logic state of the received PAM-3 signal based on the NRZ interface.

A test result may be generated by comparing the data written to the device under test 32 with the data read. According to an example embodiment, the test result may be determined by the translation device 10 or the test device 20. When the written data and the read data are the same, the test result may be a pass. When at least one bit of the written data and the read data is different, the test result may be a failure.

A test system 1 in an example embodiment may include a translation device 10 for interface translation between NRZ and PAM-3. The device under test 32 based on the PAM-3 interface may be tested using the existing test device 20 based on the NRZ interface. Accordingly, it may be unnecessary to have a separate test device supporting the PAM-3 interface, and the device under test 32 based on the PAM-3 interface may be tested without the cost of adding a separate expensive component for translation between different interfaces.

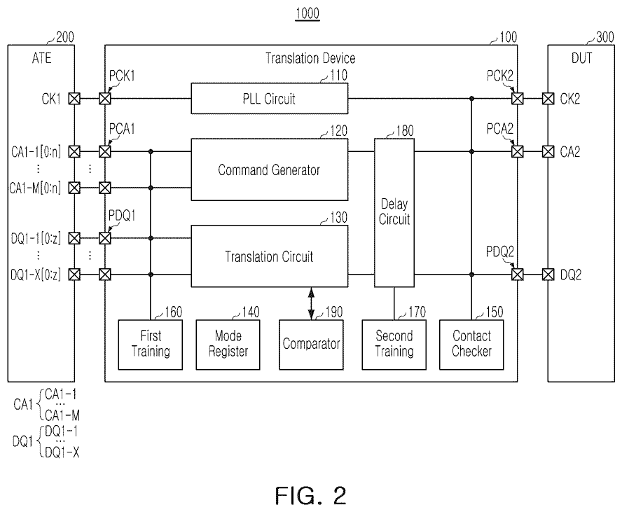

FIG. 2 is a block diagram illustrating a test system according to an example embodiment.

Referring to FIG. 2, a test system 1000 may include a translation device 100, a test device 200, and a device under test 300. The test system 1000 may correspond to a specific example of the test system 1 illustrated in FIG. 1. The device under test 300 may be physically connected to a test board (not shown) through a socket, and may communicate with the translation device 100 and/or the test device 200 through the test board.

The test device 200 may transmit or receive a first signal according to an NRZ method, and the device under test 300 may transmit or receive a second signal according to an NRZ method and/or a PAM-3 method. In this case, the first signal may be transmitted at a first speed, and the second signal may be transmitted at a second speed different from the first speed. The unit of the first speed and the second speed may be Gigabits per second (Gbps) or Giga baud rate (Gbaud), and the second speed may be equal to or greater than the first speed. The translation device 100 may be disposed between the test device 200 and the device under test 300 so as to translate the first signal of the first speed into the second signal of the second speed. Accordingly, a test may be enabled using the existing test device 200.

Referring to FIG. 2, the translation device 100 may include a first input/output circuit (not shown) including a plurality of first pins PCK1, PCA1, and PDQ1, a second input/output circuit (not shown) including a plurality of second pins PCK2, PCA2, and PDQ2, a phase locked loop (PLL) circuit 110, a command generator 120, a translation circuit 130, and a mode register 140.

The translation device 100 may be connected to the test device 200 through a plurality of first pins PCK1, PCA1, and PDQ1. The translation device 100 and the test device 200 may transmit and receive first signals CK1, CA1, and DQ1 through a plurality of first pins PCK1, PCA1, and PDQ1. The first signals CK1, CA1, and DQ1 may include a first clock signal CK1, a first command/address signal CA1, and a first data signal DQ1. The first clock signal CK1 may be a periodic pulse signal provided to operate the test system 1000. The first command/address signal CA1 may be a signal instructing the device under test 300 to write or read data and a signal transmitting an address to which data is transmitted. The first data signal DQ1 may be a signal transmitting a data value according to the first clock signal CK1 and the first command/address signal CA1.

The plurality of first pins PCK1, PCA1, and PDQ1 may include one first clock pin PCK1, a plurality of first command/address pins PCA1, and a plurality of first data pins PDQ1. As the example embodiment illustrated in FIG. 2, the first clock signal CK1 may be transmitted through the first clock pin PCK1.

A first command/address signal CA1 may be transmitted through the plurality of first command/address pins PCA1. As the example embodiment illustrated in FIG. 2, a first command/address signal CA1 may include 1-1 to 1-M command/address signals CA1 to CAM, and the 1-1 to 1-M command/address signals CA1 to CAM may be transmitted through different channels. As the example embodiment illustrated in FIG. 2, each of the 1-1 to 1-M command/address signals CA1-1 to CA1-M may be an n+1 bit signal, and each of the n+1 bits may have a unique value. Each channel may include n+1 pins of the first command/address pins PCA1. Accordingly, each of the n+1 bit signals of the 1-1 to 1-M command/address signals CA1-1 to CA1-M may be transmitted in parallel through different first command/address pins.

The first data signal DQ1 may be transmitted and received through a plurality of first data pins PDQ1. As the example embodiment illustrated in FIG. 2, the first data signal DQ1 may include 1-1 to 1-X data signals DQ1-1 to DQ1-X, and the 1-1 to 1-X data signals DQ1-1 to DQ1-X may be transmitted and received through different channels. As the example embodiment illustrated in FIG. 2, each of the 1-1 to 1-X data signals DQ1-1 to DQ1-X may be a z+1 bit signal, and each of the z+1 bits may have a unique value. Each channel may include z+1 pins from among the first data pins PDQ1. Accordingly, the z+1 bit signals of each of the 1-1 to 1-X data signals DQ1-1 to DQ1-X may be transmitted and received in parallel through different first data pins. In this case, the number M of first command/address pins may be less than the number Z of first data pins.

The translation device 100 may be connected to the device under test 300 through the plurality of second pins PCK2, PCA2, and PDQ2. The translation device 100 and the device under test 300 may transmit and receive second signals CK2, CA2, and DQ2 through the plurality of second pins PCK2, PCA2, and PDQ2. The second signals CK2, CA2, and DQ2 may include a second clock signal CK2, a second command/address signal CA2, and a second data signal DQ2. The second clock signal CK2 may be a periodic pulse signal provided to operate the test system 1000. The second command/address signal CA2 may be a signal instructing the device under test 300 to write or read data and a signal transmitting an address to which data is transmitted. The second data signal DQ2 may be a signal transmitting a data value according to the second clock signal CK2 and the second command/address signal CA2.

A plurality of second pins PCK2, PCA2, and PDQ2 may form one channel of the device under test 300. The plurality of second pins PCK2, PCA2, and PDQ2 may include one second clock pin PCK2, one second command/address pin PCA2, and one second data pin PDQ2. Accordingly, the number of plurality of first pins 1+M+Z may be greater than the number of plurality of second pins (3).

As the example embodiment illustrated in FIG. 2, a second clock signal CK2 may be transmitted through the second clock pin PCK2. The second clock signal CK2 may be a signal according to the NRZ method, similarly to the first clock signal CK1. The second command/address signal CA2 may be transmitted through the second command/address pin PCA2. The second command/address signal CA2 may be a signal according to the NRZ method, similarly to the first command/address signal CA1. The second data signal DQ2 may be transmitted and received through the second data pin PDQ2. The second data signal DQ2 may be a signal translated from the first data signal DQ1 according to the NRZ method to the PAM-3 method.

The PLL circuit 110 may multiply the first clock signal CK1 and the second clock signal CK2 and output the signals. According to an example embodiment, the PLL circuit 110 may amplify or attenuate the frequency of the received signal by a predetermined multiple. The predetermined multiple may correspond to 1, 2, 4, 8, or the like. When the translation device 100 receives the first clock signal CK1 from the test device 200 through the first clock pin PCK1, the PLL circuit 110 may multiply the first clock signal CK1 and may generate the second clock signal CK2. The multiplied second clock signal CK2 may be output through the second clock pin PCK2.

The command generator 120 may transmit the first command/address signal CA1 to the second command/address signal CA2 in accordance with the multiplied first clock signal. In an example embodiment, the command generator 120 may transmit the second command/address signal CA2 through the second command/address pin PCA2 in accordance with the second clock signal CK2.

The translation circuit 130 may translate the first data signal DQ1 according to the NRZ method into the second data signal DQ2 according to the PAM-3 method, and may translate the second data signal DQ2 according to the PAM-3 method into the first data signal DQ1 according to the NRZ method. The first data signal DQ1 may include a plurality of bits, and the second data signal DQ2 may include a plurality of symbols. Specifically, the translation circuit 130 may translate bits of a signal according to the NRZ method into symbols of a signal according to the PAM-3 method and may transmit the symbols through the second data pin PDQ2. Also, the translation circuit 130 may translate symbols of a signal according to the PAM-3 method into bits of a signal according to an NRZ method and transmit the symbols through the first data pins PDQ1.

The translation circuit 130 may operate as a translation method configured to translate at least two bits of a first data signal DQ1 into at least one symbol of a second data signal. At least one symbol of a second data signal DQ2 may be translated into a plurality of bits of the first data signal DQ1. For example, 11 bits may be translated into 7 symbols, or 7 bits may be translated into 4 symbols. 5 bits may be translated into 3 symbols, or 3 bits may be translated into 2 symbols. 2 bits may be translated into 1 symbol, but an example embodiment thereof is not limited thereto.

The mode register 140 may store pieces of information for the translation device 100 to operate. The operation of the translation device 100 may be controlled according to the pieces of information stored in the mode register 140. The pieces of information may include information on at least one of a first speed, a second speed, the number of first pins, or the number of second pins. Also, the pieces of information may further include an interface type (NRZ or PAM-3) of the device under test 300, a translation method of the translation circuit 130, or the like.

The test system 1000 in an example embodiment may generate a test result by comparing write data written to the device under test 300 with read data read from the written data. When the write data and the read data are the same, the test result may be a pass. When at least one bit of the write data and the read data is different, the test result may be a failure.

Referring to FIG. 2, the translation device 100 in an example embodiment may further include at least one of a contact checker 150, a first training circuit 160, a second training circuit 170, a delay circuit 180, and a comparator 190. By including at least one of the contact tester 150, the first training circuit 160, the second training circuit 170, or the delay circuit 180, accuracy of the test result may be improved. The translation device 100 including the comparator 190 may directly generate a test result and may transmit the generated test result to the test device 200.

The contact checker 150 may test whether a plurality of pins included in the translation device 100 and the device under test 300 are physically normally connected. For example, the contact checker 150 may determine whether the translation device 100 and the device under test 300 are physically normally connected by applying current to each of the plurality of second pins PCK2, PCA2, and PDQ2 of the translation device 100. Accordingly, using the result of the contact tester 150, it may be determined whether the test result of fail is due to a poor physical connection between the translation device 100 and the device under test 300.

The first training circuit 160 may control signals transmitted and received between the test device 200 and the translation device 100 to be input simultaneously. For example, the time point at which signals are received through each of a plurality of pins in the test device 200 and the translation device 100 may be controlled. The signals may include a first clock signal CK1, a first command/address signal CA1, and a first data signal DQ1.

The pins of the test device 200 and the translation device 100 may be connected to a transmission line, such that signals may be transmitted and received. In this case, the time points at which signals arrive at the translation device 100 and the test device 200 may be different from each other due to differences in a length of a transmission line and a resistance value of the transmission line. Accordingly, data of signals transmitted and received between the translation device 100 and the test device 200 may be lost. The first training circuit 160 may control the signals to arrive at the translation device 100 and the test device 200 at the same time point, thereby preventing data loss.

The second training circuit 170 may control the signals transmitted and received between the translation device 100 and the device under test 300 to be input simultaneously. For example, the time point at which signals are received through each of a plurality of pins in the translation device 100 and the device under test 300 may be controlled. The signals may include a second clock signal CK2, a second command/address signal CA2, and a second data signal DQ2.

The pins of the translation device 100 and the device under test 300 may be connected to a transmission line, such that signals may be transmitted and received. In this case, the time points at which the signals arrive at the translation device 100 and the device under test 300 may be different from each other due to the difference in a length of the transmission line and a resistance value of the transmission line. Accordingly, data of signals transmitted and received between the translation device 100 and the device under test 300 may be lost. The second training circuit 170 may prevent data loss by controlling signals to arrive at the translation device 100 and the device under test 300 at the same time point.

The delay circuit 180 in an example embodiment may delay the arrival time points of signals transmitted and received between the translation device 100 and the device under test 300. The second training circuit 170 may calculate delay times of signals for each of a plurality of second pins. The delay circuit 180 may apply the calculated delay times to the plurality of second pins PCK2, PCA2, and PDQ2 and may control the signals to be input simultaneously.

The translation device 100 in an example embodiment may not directly generate a test result. The translation device 100 may translate a data signal of a PAM-3 method read and transmitted from the device under test 300 into a data signal of an NRZ method and may transmit the signal to the test device 200. In this case, the test device 200 may determine whether the written data and the read data are the same using the received data signal of the NRZ method.

The translation device 100 in another example embodiment may directly generate a test result. The translation device 100 may store a data signal of the NRZ method transmitted from the test device 200 and written to the device under test 300. The translation device 100 may determine whether the written data and the read data are the same using the stored data signal and the data signal received from the device under test 300. For example, the comparator 190 may determine whether the stored data signal and the received data signal are the same bit by bit.

According to an example embodiment, the mode register 140 may also store pieces of information about at least one of whether to operate the contact checker 150, whether to operate the first training circuit 160, whether to operate the second training circuit 170, whether to operate the delay circuit 180, and whether to operate the comparator 190. Depending on the pieces of information, whether to operate the contact checker 150, the first training circuit 160, the second training circuit 170, the delay circuit 180, and the comparator 190 may be determined.

The test system 1000 in an example embodiment may include a translation device 100 for interface translation between NRZ and PAM-3. The device under test 300 based on the PAM-3 interface may be tested using the existing test device 200 based on an NRZ interface. Accordingly, the device under test 300 may be tested based on the PAM-3 interface without a separate test device supporting the PAM-3 interface.

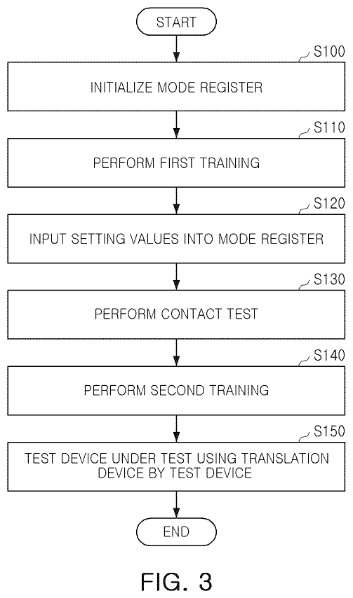

FIG. 3 is a flowchart illustrating operations of a test system according to an example embodiment.

A test system may include a translation device, a test device, and a device under test. The test device may include a PLL circuit, a command generator, a translation circuit, a mode register, a contact tester, a first training circuit, a second training circuit, and a delay circuit. Specific example embodiments of the test system and the translation device may be similar to the examples described with reference to FIG. 1 and FIG. 2 above.

Before starting a test, the test device may first perform operations (S100 to S140) for setting up the translation device. First, the test device may initialize a mode register (S100). Pieces of information stored in the mode register during the first performed test may be initialized.

The test device may perform first training using a first training circuit (S110). By the first training, signals transmitted and received between the test device and the translation device may be controlled to be input simultaneously. For example, a signal output through at least one of a plurality of first pins may be input with a delay.

The test device may input setting values into the mode register (S120). The setting values may include information about at least one of the first speed of the first signal, the second speed of the second signal, the number of first pins, and the number of second pins. Also, the setting values may also store pieces of information about at least one of whether to operate the contact tester, whether to operate the first training circuit, whether to operate the second training circuit, whether to operate the delay circuit, and whether to operate the comparator. The translation device may operate by the setting values.

Thereafter, the test device may perform a contact test using the contact checker (S130). The contact checker may test whether a plurality of pins included in the translation device and the device under test are physically and correctly connected. In the case in which the test result is a failure, it may be determined whether the failure is due to a defect in the physical connection between the translation device and the device under test or the failure is due to a defect in the device under test.

The test device may perform second training using the second training circuit (S140). By the second training, signals transmitted and received between the translation device and the device under test may be controlled to be input simultaneously. In an example embodiment, a delay time of a transmit time point of a signal output through at least one pin among a plurality of pins by the second training may be calculated. The delay circuit may reflect the calculated delay time to the pin, such that signals transmitted and received between the translation device and the device under test may be controlled to be input simultaneously.

Thereafter, the test device may test the device under test using the translation device (S150). The test device may generate write data as a first data signal according to the NRZ method and may transmit the first data signal to the translation device. The translation device may translate the first data signal into a second data signal according to the PAM-3 method and may transmit the signal to the device under test, and the device under test may store the write data from the second data signal. In this case, the translation device may also temporarily store the write data.

The test device may transmit a read command to read the write data stored in the device under test. The device under test may read the stored data and may generate the read data as a second data signal according to the PAM-3 method. The device under test may transmit the second data signal to a translation device. The translation device may translate the second data signal into a first data signal according to the NRZ method.

The translation device in an example embodiment may transmit the translated first data signal to the test device. The test device may determine the read data from the first data and may compare the write data with the read data and may generate a test result. The translation device in another example embodiment may determine the read data from the received second data signal. The translation device may directly generate a test result by comparing the stored write data with the determined read data.

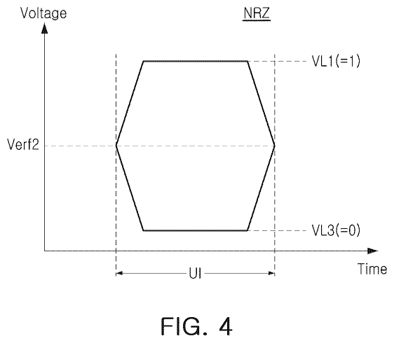

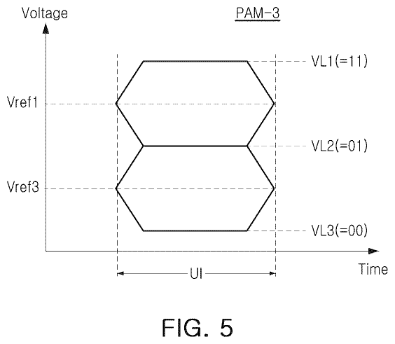

FIG. 4 is a graph illustrating a data eye indicating an NRZ method according to an example embodiment. FIG. 5 is a graph illustrating a data eye indicating a PAM-3 method according to an example embodiment.

Referring to FIG. 4 and FIG. 5, the horizontal axes may indicate time, and the vertical axes may indicate voltage levels.

First, referring to FIG. 4, the first data signal between the test device and the translation device may be transmitted using the NRZ method (or the PAM-3 method). The first data signal may be generated to have one of the first and third voltage levels VL1 and VL3. During the unit interval UI between the test device and the translation device, one bit (e.g., one of “1,” “0”) may be transmitted through the first data signal.

As the example embodiment illustrated in FIG. 4, the bit of “1” may correspond to the first voltage level VL1, and the bit of “0” may correspond to the third voltage level VL3. That is, during the unit interval UI, symbols having one of the first and third voltage levels VL1 and VL3 may be generated, and each symbol may correspond to one bit.

The first data signal transmitted by the NRZ method may be sampled based on the second reference voltage Vref2. By comparing the voltage level of the first data signal according to the NRZ method with the second reference voltage Vref2, one bit corresponding to the first data signal may be obtained.

When the voltage level of the first data signal is greater than the second reference voltage Vref2, the first data signal may be decoded as a bit of “1.” When the voltage level of the first data signal is less than the second reference voltage Vref2, the first data signal may be decoded as a bit of “0.” In other words, the bit of “1” may be encoded as the first voltage level VL1, which is a voltage level greater than the second reference voltage Vref2. The bit of “0” may be encoded as the third voltage level VL3, which is a voltage level less than the second reference voltage Vref2.

Referring to FIG. 5, the second data signal may be transmitted by the PAM-3 method between the translation device and the device under test. The second data signal may be generated to have one of the first to third voltage levels VL1, VL2, and VL3. About 1.5 bits of data (e.g., data corresponding to “11,” “01,” and “00”) may be transmitted through the second data signal during the unit interval UI between the translation device and the device under test.

As the example embodiment illustrated in FIG. 5, the bits of “11” may correspond to the first voltage level VL1, the bits of “01” may correspond to the second voltage level VL2, and the bits of “00” may correspond to the third voltage level VL3. In this case, referring also to FIG. 4, the first voltage level VL1 of the PAM-3 method may correspond to the first voltage level VL1 of the NRZ method, and the third voltage level VL3 of the PAM-3 method may correspond to the third voltage level VL3 of the NRZ method. During the unit interval UI, a symbol having one of the first to third voltage levels VL1 to VL3 may be generated, and each symbol may correspond to data corresponding to about 1.5 bits.

The second data signal transmitted by the PAM-3 method may be sampled based on the first and third reference voltages Vref1 and Vref3. Referring to FIG. 4 together, the second reference voltage Vref2 of the NRZ method may be greater than the third reference voltage Vref3 of the PAM-3 method and less than the first reference voltage Vref1. Since one symbol of the second data signal of the PAM-3 method corresponds to data corresponding to about 1.5 bits, the voltage levels of the plurality of symbols may be combined to decode into a plurality of bits. In other words, the plurality of bits may be combined and may be encoded into voltage levels of the plurality of symbols.

In FIG. 4, the reference voltage for sampling the data signal in the NRZ mode is illustrated as the second reference voltage Vref2, but an example embodiment thereof is not limited thereto. In FIG. 5, reference voltages for sampling data signals in PAM-3 mode are illustrated as first and third reference voltages Vref1 and Vref3, but an example embodiment thereof is not limited thereto.

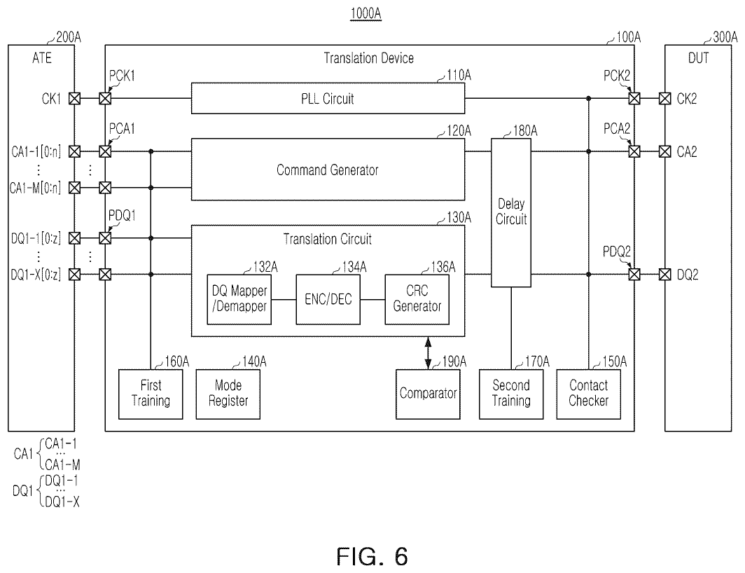

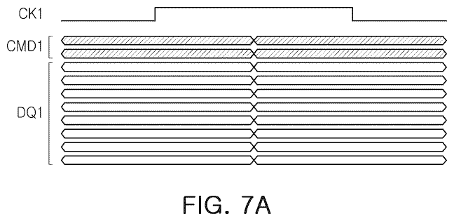

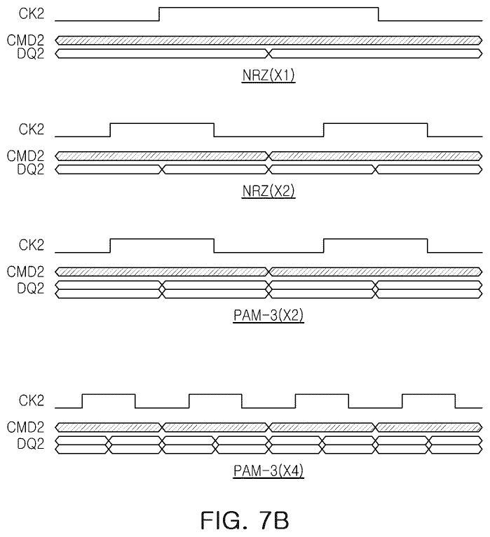

FIG. 6 is a block diagram illustrating a test system according to an example embodiment. FIG. 7A is a diagram illustrating a first signal of a test system according to an example embodiment. FIG. 7B is a diagram illustrating a second signal of a test system according to an example embodiment.

Referring to FIG. 6, a test system 1000A may include a translation device 100A, a test device 200A, and a device under test 300A. Specific example embodiments of the test system 1000A and the translation device 100A may be similar to the examples described above with reference to FIGS. 1 to 5. The test system 1000A may test one channel of the device under test 300A. Hereinafter, the translation circuit 130A in the example embodiment illustrated in FIG. 6 will be described in greater detail.

The translation device 100A in the example embodiment illustrated in FIG. 6 may receive the entirety of data necessary to test one channel of the device under test 300A from the test device 200A. In other words, the translation device 100A may not copy the commands and/or data received from the test device 200A.

The translation circuit 130A may include a data mapper/demapper 132A, a decoder/encoder 134A, and a cyclic redundancy check (CRC) generator 136A.

The data mapper/demapper 132A may combine pieces of data into specific positions. In an example embodiment, the data mapper/demapper 132A may operate as a demapper to write data in the device under test 300A. In this case, the data mapper/demapper 132A may combine pieces of bit data transmitted through a plurality of first data pins PDQ1 into specific positions, and may temporarily store the pieces of bit data until a predetermined number of bit data are combined. For example, when 256 pieces of bit data are combined, the data mapper/demapper 132A may transmit the 256 the combined bit data to the decoder/encoder 134A.

In another example embodiment, when data is read from the device under test 300A, the data mapper/demapper 136A may operate as a demapper. In this case, the data mapper/demapper 136A may distinguish the read data for a plurality of first data pins PDQ1 and may transmit the data to each of the plurality of first data pins PDQ1.

The decoder/encoder 134A may encode and decode the data signal and may translate the signal into a data signal of another method. In an example embodiment, in order to write data in the device under test 300A, the decoder/encoder 134A may operate as an encoder. In this case, the decoder/encoder 134A may encode pieces of bit data according to the NRZ method and may translate the data into PAM-3 symbols. The PAM-3 symbols may be transmitted to the CRC generator 136A.

In another example embodiment, when data is read from the device under test 300A, the decoder/encoder 134A may operate as a decoder. In this case, the decoder/encoder 134A may decode PAM-3 symbols and may translate the symbols into pieces of bit data according to the NRZ method. The pieces of bit data may be transmitted to the data mapper/demapper 132A.

The CRC generator 136A may add a CRC code to the PAM-3 data signal by generating a specific polynomial, or may remove a CRC code included in the PAM-3 data signal. In an example embodiment, in order to write data in the device under test 300A, the CRC generator 136A may add a CRC code to the end of a signal transmitted from the decoder/encoder 134A. The CRC code may be used to detect an error in the signal. The CRC generator 136A may transmit the signal with the CRC code added to the device under test 300A.

In another example embodiment, when data is read from the device under test 300A, the CRC generator 136A may remove the CRC code from the signal transmitted from the device under test 300A. The signal with the CRC code removed may be transmitted to the decoder/encoder 134A.

In an example embodiment, the test device 200A may be based on an NRZ interface, and the speed of the first signal according to the NRZ method may be 4 Gbps. The device under test 300A may be based on a PAM-3 interface, and the speed of the second signal according to the PAM-3 method may be 16 Gbaud. One PAM-3 symbol may include data corresponding to about 1.5 bits. In order to encode by the PAM-3 method, 256 pieces of bit data may be required. The 256 pieces of bit data may be translated into 176 PAM-3 symbols. However, an example embodiment thereof is not limited thereto.

In an example embodiment, the translation device 100A may transmit a second data signal DQ2 to, and receive the second data signal DQ2 from, the device under test 300A through the second channel. Since the device under test 300A may include 11 second channels, one second channel of the device under test 200A may transmit and receive 16 PAM-3 symbols. Accordingly, eight rising and falling edges of the second clock signal CK2 may be required during one period.

In an example embodiment, the translation device 100A may transmit a first data signal DQ1 to, and receive the first data signal DQ1 from, the test device 200A through eight first channels. In this case, the first data signal DQ1 may include 1-1 to 1-8 data signals DQ1-1 to DQ1-8. One first channel may require 16 pieces of bit data during one period, and one first channel may include eight first data pins PDQ1.

The translation device 100A may receive the first command/address signal CA1 from the test device 200A through five first channels. In this case, the first command/address signal CA1 may include 1-1 and 1-2 command/address signals CA1-1 and CA1-2. One first channel may include two first command/address pins PCA1.

The translation device 100A may transmit the second command/address signal CA2 to the device under test 300A through one second channel. One second channel may require four command/address signals during one period, and one second channel may include one second command/address pins PCA2.

FIG. 7A illustrates the first signal according to the NRZ method, transmitted and received by the translation device 100A and the test device 200A. The first signal may include a first clock signal CK1, a first command/address signal CA1, and a first data signal DQ1. The example embodiment illustrated in FIG. 7A indicates during one period of the first clock signal CK1, the first command/address signal CMD1 (or CA1) transmitted through one channel and the first data signal DQ1 transmitted and received through one channel.

According to an example embodiment, at each of the rising edge and falling edge of the first clock signal CK1, the first command/address signal CA1 and the first data signal DQ1 may be transmitted. Specifically, at each of the rising edge and falling edge of the first clock signal CK1, the 1-1 and 1-2 command/address signals CA1-1 and CA1-2 and the 1-1 to 1-8 data signals DQ1-1 to DQ1-8 may be transmitted. That is, at each of the rising edge and falling edge of the first clock signal CK1, two command/address signals and eight data signals may be transmitted.

Referring to FIG. 7B, the second signal transmitted and received by the translation device 100A and the device under test 300A may be represented. The second signal may include a second clock signal CK2, a second command/address signal CA2, and a second data signal DQ2. According to the example embodiment illustrated in FIG. 7B, during one period of the second clock signal CK2, the second command/address signal CMD2 (or CA2) may be transmitted and received through one channel, and the second data signal DQ2 may be transmitted and received.

In an example embodiment, the device under test 300A may be based on NRZ and PAM-3 interfaces. The test device 200A may test both the device under test 300A based on the NRZ interface and the device under test 300A based on the PAM-3 interface. Hereinafter, the second signal according to the interface and the speed of the second signal of the device under test 300A will be described with reference to the second signals illustrated in FIG. 7B.

As a first example embodiment, the device under test 300A may be based on an NRZ interface, and the speed of the second signal may be 4 Gbps. The frequency of the second clock signal CK2 may be the same (×1) as the frequency of the first clock signal CK1 in the example embodiment illustrated in FIG. 7A.

During one period, each of the rising and falling edges of the second clock signal CK2 may be required once. In other words, during one period, the second clock signal CK2 may include one rising edge and one falling edge, and accordingly, one second command CMD2 may be required during one period. The translation circuit 130A may sequentially output two bits of data among the 16 pieces of bit data included in the first data signal DQ1 in FIG. 7A in accordance with the rising edge and the falling edge of the second clock signal CK2.

As a second example embodiment, the device under test 300A may be based on an NRZ interface, and the speed of the second signal may be 8 Gbps. The frequency of the second clock signal CK2 may be twice (×2) the frequency of the first clock signal CK1 in the example embodiment illustrated in FIG. 7A.

During one period, each of the rising and falling edges of the second clock signal CK2 may be required twice. In other words, during one period, the second clock signal CK2 may include two rising edges and two falling edges, and accordingly, two second commands CMD2 may be required during one period. The translation circuit 130A may sequentially output four-bit data out of the 16 pieces of bit data included in the first data signal DQ1 in FIG. 7A in accordance with the rising edge and falling edge of the second clock signal CK2.

As a third example embodiment, the device under test 300A may be based on a PAM-3 interface, and the speed of the second signal may be 8 Gbaud. The frequency of the second clock signal CK2 may be twice (×2) the frequency of the first clock signal CK1 in the example embodiment illustrated in FIG. 7A.

During one period, each of the rising and falling edges of the second clock signal CK2 may be required twice. In other words, during one period, the second clock signal CK2 may include two rising edges and two falling edges, and accordingly, two second commands CMD2 may be required during one period. The translation circuit 130A may translate eight-bit data out of the 16 pieces of bit data included in the first data signal DQ1 in FIG. 7A into four PAM-3 symbols. The four PAM-3 symbols may be sequentially output in accordance with the rising and falling edges of the second clock signal CK2.

As a fourth example embodiment, the device under test 300A may be based on a PAM-3 interface, and the speed of the second signal may be 16 Gbaud. The frequency of the second clock signal CK2 may be four times (×4) the frequency of the first clock signal CK1 in the example embodiment illustrated in FIG. 7.

Each of the rising and falling edges of the second clock signal CK2 may be required four times during one period. In other words, during one period, the second clock signal CK2 may include four rising edges and four falling edges, and accordingly, four second commands CMD2 may be required during one period. The translation circuit 130A may translate the 16 pieces of bit data included in the first data signal DQ1 in FIG. 7A into eight PAM-3 symbols. The eight PAM-3 symbols may be sequentially output in accordance with the rising and falling edges of the second clock signal CK2.

The translation device 100A in the first to third example embodiment may translate a portion of the first command/address signal CA1 transmitted from the test device 200A into a second command/address signal CA2. Also, the translation device 100A in the first to third example embodiment may translate a portion of the first data signal DQ1 transmitted from the test device 200A into a second data signal DQ2.

Differently from the above example, the translation device 100A in the fourth example embodiment may translate the entirety of the first command/address signal CA1 transmitted from the test device 200A into a second command/address signal CA2. Also, the translation device 100A in the first to third example embodiment may translate the entirety of the first data signal DQ1 transmitted from the test device 200A into a second data signal DQ2.

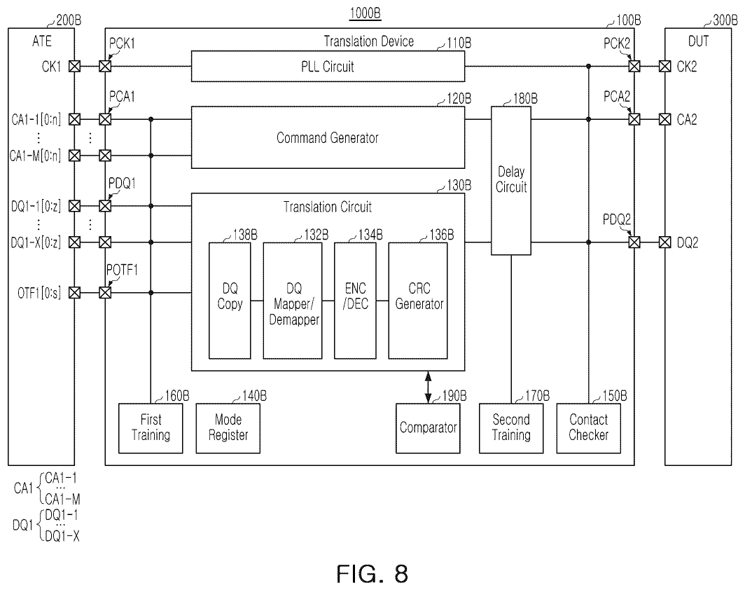

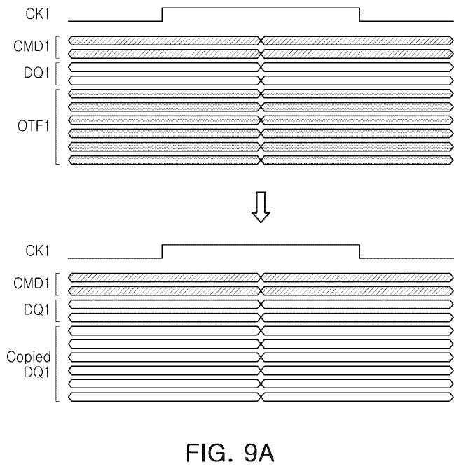

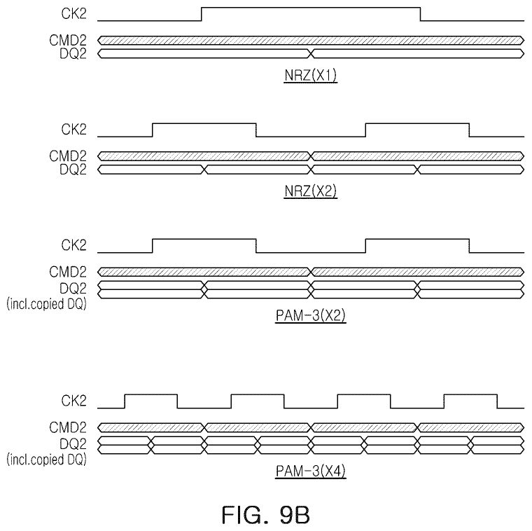

FIG. 8 is a block diagram illustrating a test system according to an example embodiment. FIG. 9A is a diagram illustrating a first signal of a test system according to an example embodiment. FIG. 9B is a diagram illustrating a second signal of a test system according to an example embodiment.

Referring first to FIG. 8, a test system 1000B may include a translation device 100B, a test device 200B, and a device under test 300B. Specific example embodiments of the test system 1000B and the translation device 100B may be similar to the examples described above with reference to FIGS. 6, 7A, and 7B. Differences from the example embodiment illustrated in FIG. 6 will be described below.

In the example embodiment illustrated in FIG. 8, the test device 200B may transmit a first on the fly (OTF) signal to the translation device 100B through the first OTF pin POTF1. The translation circuit 130B may further include a data signal copy (DQ copy) 138B. The data signal copy 138B may copy the first data signal transmitted through at least one first data pin PDQ1 using the first OTF signal. The first OTF signal may be an (s+1) bit signal, and the (s+1) bit signals may be transmitted in parallel through different first OTF pins.

Comparing the translation circuit 130A in FIG. 6 with the translation circuit 130B in FIG. 8, there may be a difference in whether the entirety of the pieces of bit data required to translate the method of the data signal are input from the test devices 200A and 200B. The translation circuit 130A in FIG. 6 may receive the entirety of the pieces of bit data required to translate the signal method through the first data pins PDQ1. Differently from the above example, the translation circuit 130B in FIG. 8 may receive a portion of the required pieces of bit data through the first data pins PDQ1, and the other may be copied by the data signal copy 138B.

The translation device 100B in FIG. 8 may test one channel of the device under test 300B using a portion of a plurality of first data pins PDQ1. Accordingly, other channels or other devices under test may be tested simultaneously using the other first data pins of the plurality of first data pins PDQ1. However, since the data signal is copied and the signal method is translated, tests for the entirety of data combinations may not be performed. Accordingly, accuracy of the test result may be reduced.

According to an example embodiment described with reference to FIG. 6 above, the test device 200B may be based on an NRZ interface, and the speed of the first signal according to the NRZ method may be 4 Gbps. The device under test 300B may be based on a PAM-3 interface, and the speed of the second signal according to the PAM-3 method may be 16 Gbaud. 256 pieces of bit data may be translated into 176 PAM-3 symbols. However, an example embodiment thereof is not limited thereto.

In an example embodiment, the translation device 100B may transmit a second data signal DQ2 to, and receive the second data signal DQ2 from, the device under test 300B through a second channel. Since the translation device 100B may include 11 second channels, one second channel may transmit and receive 16 PAM-3 symbols. Accordingly, eight rising and falling edges of the second clock signal CK2 may be required during one period. Accordingly, two rising and falling edges of the first clock signal CK1 may be required during one period.

In an example embodiment, the translation device 100B may transmit a first data signal DQ1 to, and receive the first data signal DQ1 from, the test device 200B through two first channels. In this case, the first data signal DQ1 may include 1-1 and 1-2 data signals DQ1-1, DQ1-2. One first channel may require 16 pieces of bit data during one period, and one first channel may include two first data pins PDQ1.

The translation device 100B may include six first OTF pins POTF1, and the first OTF signal may be a 6-bit signal. For example, the bit data included in the first data signal DQ1 may be copied or inverted depending on the first OTF signal. However, the number of first OTF pins POTF1 may not be limited thereto.

The translation device 100A may receive the first command/address signal CA1 from the test device 200A through five first channels. In this case, the first command/address signal CA1 may include 1-1 and 1-2 command/address signals CA1-1 and CA1-2. A first channel may require four command/address signals during one period, and a first channel may include two first command/address pins PCA1.

The translation device 100A may transmit a second command/address signal CA2 to the device under test 300A through one second channel. One second channel may require four command/address signals during one period. The translation device 100A may include one second command/address pin in one second channel.

FIG. 9A illustrates the first signal according to the NRZ method transmitted and received by the translation device 100B and the test device 200B. The first signal may include a first clock signal CK1, a first command/address signal CA1, a first data signal DQ1, and a first OTF signal (OTF). According to the example embodiment illustrated in FIG. 9A, two command/address signals, two data signals, and a 6-bit first OTF signal may be transmitted at each of the rising edge and falling edge of the first clock signal CK1.

At each of the rising edge and falling edge of the first clock signal CK1, the two data signals may be copied three times by the first OTF signal, such that 6-bit data may be copied. For example, when the first OTF signal is at a high level, the two data signals may be inverted, and when the first OTF signal is at a low level, the two data signals may be copied equally. The translation device 100B may translate the two data signals and the copied data signal into a signal according to the PAM-3 method.

FIG. 9B illustrates the second signal transmitted and received by the translation device 100B and the device under test 300B. The second signal may include the second clock signal CK2, the second command/address signal CA2, and the second data signal DQ2. According to the example embodiment illustrated in FIG. 9B, during one period of a second clock signal CK2, a second command/address signal CMD2 (or CA2) may be transmitted and a second data signal DQ2 may be transmitted and received in one second channel.

In an example embodiment, the device under test 300B may be based on NRZ and PAM-3 interfaces. The test device 200B may test both the device under test 300B based on NRZ interface and the device under test 300B based on PAM-3 interface. Hereinafter, the second signal according to the interface and the speed of the second signal of the device under test 300B will be described with reference to the second signals illustrated in FIG. 9B in order.

In a first example embodiment, the device under test 300B may be based on NRZ interface, and the speed of the second signal may be 4 Gbps. The frequency of the second clock signal CK2 may be the same as (×1) the frequency of the first clock signal CK1 in the example embodiment illustrated in FIG. 9A.

Each of the rising and falling edges of the second clock signal CK2 may be required once during one period, and one second command CMD2 may be required during one period. The translation circuit 130B may output two bits of data among the four pieces of bit data included in the first data signal DQ1 in FIG. 9A in sequence in accordance with the rising edge and falling edge of the second clock signal CK2.

In a second example embodiment, the device under test 300B may be based on an NRZ interface, and the speed of the second signal may be 8 Gbps. The frequency of the second clock signal CK2 may be twice (×2) the frequency of the first clock signal CK1 in the example embodiment illustrated in FIG. 9A.

During one period, each of the rising and falling edges of the second clock signal CK2 are required twice, and two second commands CMD2 may be required during one period. The translation circuit 130B may output four pieces of bit data included in the first data signal DQ1 in FIG. 9A in sequence in accordance with the rising and falling edges of the second clock signal CK2.

In a third example embodiment, the device under test 300B may be based on a PAM-3 interface, and the speed of the second signal may be 8 Gbaud. The frequency of the second clock signal CK2 may be twice (×2) the frequency of the first clock signal CK1 in the example embodiment illustrated in FIG. 9A.

During one period, each of the rising and falling edges of the second clock signal CK2 are required twice, and two second commands CMD2 may be requested during one period. Four pieces of bit data included in the first data signal DQ1 in FIG. 9A, and four pieces of bit data among the 12 pieces of bit data included in the copied first data signal (copied DQ1) may be translated into four PAM-3 symbols by the translation circuit 130B. The four PAM-3 symbols may be output in sequence in accordance with the rising edge and falling edge of the second clock signal CK2.

In the fourth example embodiment, the device under test 300B may be based on a PAM-3 interface, and the speed of the second signal may be 16 Gbaud. The frequency of the second clock signal CK2 may be four times (×4) the frequency of the first clock signal CK1 in the example embodiment illustrated in FIG. 9A.

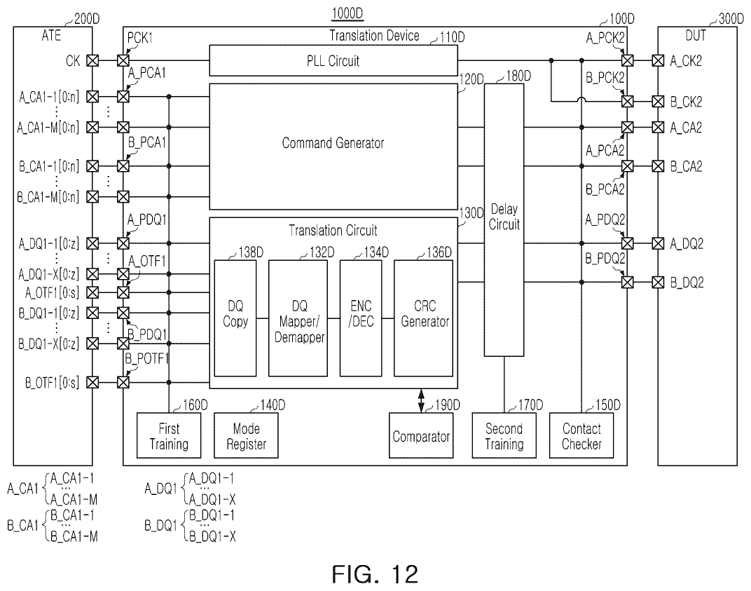

Each of the rising and falling edges of the second clock signal CK2 may be required four times during one period, and four second commands CMD2 may be required during one period. Four pieces of bit data included in the first data signal DQ1 in FIGS. 9A and 12 pieces of bit data included in the copied first data signal (copied DQ1) may be translated into eight PAM-3 symbols by the translation circuit 130B. The eight PAM-3 symbols may be output in accordance with the rising and falling edges of the second clock signal CK2 in sequence.

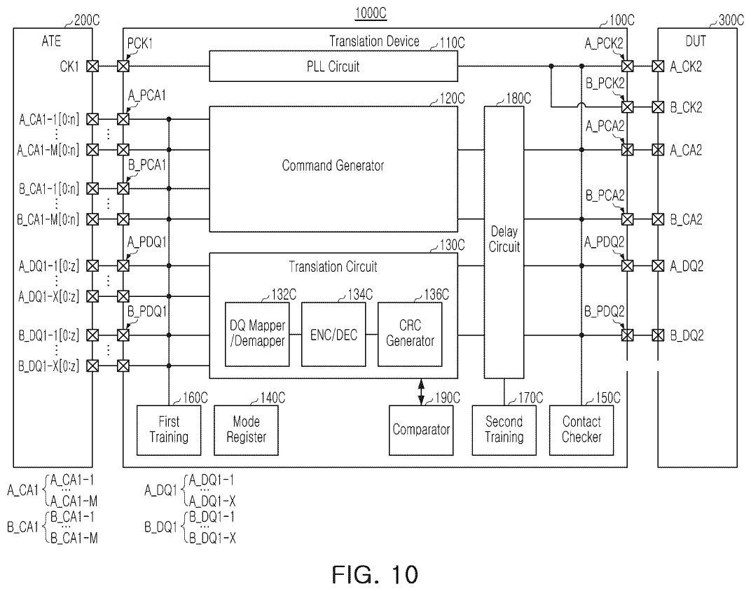

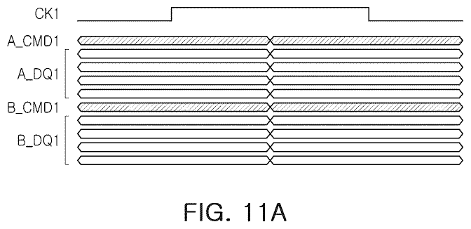

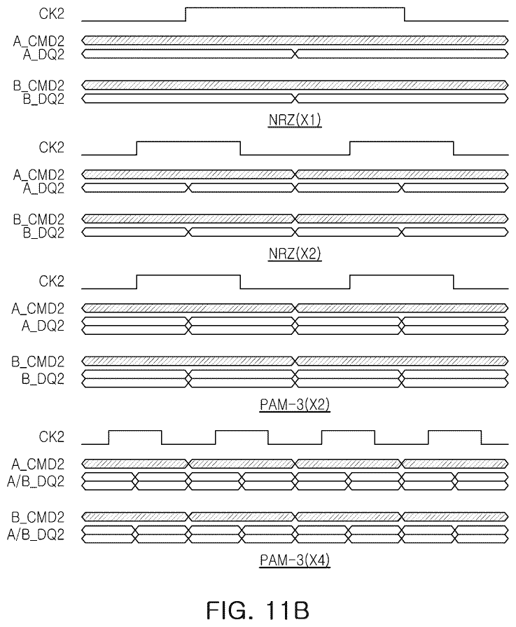

FIG. 10 is a block diagram illustrating a test system according to an example embodiment. FIG. 11A is a diagram illustrating a first signal of a test system according to an example embodiment. FIG. 11B is a diagram illustrating a second signal of a test system according to an example embodiment.

Referring first to FIG. 10, a test system 1000C may include a translation device 100C, a test device 200C, and a device under test 300C. Specific example embodiments of the test system 1000C and the translation device 100C may be similar to the examples described above with reference to FIGS. 6, 7A, and 7B. Differences from the example embodiment illustrated in FIG. 6 will be described below.

A plurality of channels of the device under test 300C may be tested simultaneously. In the example embodiment illustrated in FIG. 10, a channel A and a channel B of the device under test 300C may be tested simultaneously. The test device 200C may transmit a first command/address signal A_CA1 of the channel A of the device under test 300C, and a first data signal A_DQ1 of the channel A to the translation device 100C. Also, the test device 200C may transmit the first command/address signal B_CA1 of the channel B and the first data signal B_DQ1 of the channel B of the device under test 300C to the translation device 100C.

The command generator 120C may transmit the first command/address signal A_CA1 and the second command/address signal A_CA2 of the channel A, respectively, in accordance with the multiplied first clock signal. The command generator 120C may transmit the second command/address signal A_CA1 of the channel A through the second command/address pins A_PCA2 of the channel A in accordance with the second clock signal CK2. Also, the command generator 120C may transmit the first command/address signal B_CA1 of the channel B through the second command/address pin B_PCA2 of the channel B in accordance with the second clock signal CK2.

The translation device 100C in FIG. 10 may translate signals for simultaneously testing a plurality of channels. In an example embodiment, the plurality of channels are included in the device under test 300C, and each of the plurality of channels may operate independently. According to an example embodiment described with reference to FIG. 6, the test device 200C may be based on an NRZ interface, and the speed of the first signal according to the NRZ method may be 4 Gbps. The device under test 300C may be based on a PAM-3 interface, and the speed of the second signal according to the PAM-3 method may be 16 Gbaud. 256 pieces of bit data may be translated into 176 PAM-3 symbols. However, but an example embodiment thereof is not limited thereto.

In an example embodiment, the translation device 100C may transmit and receive a second data signal DQ2 with the device under test 300C through the second channel. The translation device 100C may include 11 second channels, such that one second channel may transmit and receive 16 PAM-3 symbols. Accordingly, 8 rising and falling edges of the second clock signal CK2 may be required during one period.

Accordingly, the frequency of the second clock signal CK2 may be 4 times the frequency of the first clock signal CK1. The speed of the second clock signal CK2 may be a 4-times multiplication of the speed of the first clock signal CK1. Accordingly, 2 rising and falling edges of the first clock signal CK1 may be required during one period.

An example embodiment of the translation device 100C illustrated in FIG. 10 may transmit the second clock signal CK2 in parallel to each of the channel A and the channel B. In other words, the second clock signal A_CK2 of the channel A may be transmitted through the second clock pin A_PCK2 of the channel A, and the second clock signal B_CK2 of the channel B may be transmitted through the second clock pin B_PCK2 of the channel B. The second clock signal A_CK2 of the channel A may be the same as the second clock signal B_CK2 of the channel B.

In an example embodiment, the translation device 100C may receive the first data signal A_DQ1 of the channel A from the test device 200C through eight first channels, and may receive the first data signal B_DQ1 of the channel B from the test device 200C through eight first channels. In this case, the first data signal A_DQ1 of the channel A may include the 1-1 to 1-8 data signals A_DQ1-1 to A_DQ1-8 of the channel A, and the first data signal B_DQ1 of the channel B may include the 1-1 to 1-8 data signals B_DQ1-1 to B_DQ1-8 of the channel B.

During a period, one first channel may require eight pieces of bit data. Accordingly, one first channel may include four first data pins A_PDQ1 of the channel A or four first data pins B_PDQ1 of the channel B.

The translation device 100C may receive a first command/address signal A_CA1 of the channel A from the test device 200C through five first channels, and may receive a first command/address signal B_CA1 of the channel B from the test device 200C through five first channels. In this case, the first command/address signal A_CA1 of the channel A may include 1-1 to 1-5 command/address signals A_CA1-1 to A_CA1-5 of the channel A. The first command/address signal B_CA1 of the channel B may include the 1-1 to 1-5 command/address signals B_CA1-1 to B_CA1-5 of the channel B.

During one period, one first channel may require five command/address signals. Accordingly, one first channel may include the five first command/address pins A_PCA1 of the channel A or the five first command/address pins B_PCA1 of the channel B.

The translation device 100C may transmit the second command/address signal A_CA2 of the channel A to the device under test 300C through the channel A, and may transmit the second command/address signal B_CA2 of the channel B to the device under test 300C through the channel B. Each of the channel A and the channel B may require four command/address signals during one period. The translation device 100C may include one second command/address pin of the channel A and one second command/address pin of the channel B.

The translation circuit 130C may include a data mapper/demapper 132C, a decoder/encoder 134C, and a cyclic redundancy check (CRC) generator 136C. The components may operate independently for the channel A and the channel B of the device under test 300C.

FIG. 11A illustrates the first signal according to the NRZ method transmitted and received by the translation device 100C and the test device 200C. The first signal may include a first clock signal CK1, a first command/address signal A_CA1 of the channel A, a first data signal A_DQ1 of the channel A, a first command/address signal B_CA1 of the channel B, and a first data signal B_DQ1 of the channel B.

According to the example embodiment illustrated in FIG. 11A, at each of the rising edge and falling edge of the first clock signal CK1, a first command/address signal A_CA1 of one A channel, a first data signal A_DQ1 of three A channels, a first command/address signal B_CA1 of one channel B, and a first data signal B_DQ1 of three channels B may be transmitted.

FIG. 11B illustrates a second signal transmitted and received by the translation device 100C and the device under test 300C. The second signal may include a second clock signal CK2, a second command/address signal A_CA2 of the channel A, a second data signal A_DQ2 of the channel A, a second command/address signal B_CA2 of the channel B, and a second data signal B_DQ2 of the channel B. In this case, the second clock signal CK2 may be the same as the second clock signal A_CK2 of the channel A and the second clock signal B_CK2 of the channel B, and may be transmitted similarly to each of the channel A and channel B. During one period of the second clock signal CK2, each of the channel A and channel B may transmit one second command/address signal CA2 and may transmit and receive one second data signal DQ2.

In an example embodiment, the device under test 300C may be based on NRZ and PAM-3 interfaces. The test device 200C may test both the device under test 300C based on the NRZ interface and the device under test 300C based on the PAM-3 interface. Hereinafter, the second signals according to the interface and the speed of the second signal of the device under test 300C will be described with reference to the second signals illustrated in FIG. 11B in order.

In a first example embodiment, the device under test 300C may be based on an NRZ interface, and the speed of the second signal may be 4 Gbps. The frequency of the second clock signal CK2 may be the same as (×1) the frequency of the first clock signal CK1 in the example embodiment illustrated in FIG. 11A.

In each of the channel A and the channel B, each of the rising and falling edges of the second clock signal CK2 may be required once during one period, and one second command CMD2 may be required during one period. The translation circuit 130C may sequentially output two bits of data among eight pieces of bit data included in the first data signal A_DQ1 of the channel A in FIG. 11A to the channel A in accordance with the rising edge and the falling edge of the second clock signal CK2. Also, the translation circuit 130C may transmit two bits of data among the eight pieces of bit data included in the first data signal B_DQ1 of the channel B in FIG. 11A to the channel B in sequence in accordance with the rising edge and falling edge of the second clock signal CK2.

In the second example embodiment, the device under test 300C may be based on an NRZ interface, and the speed of the second signal may be 8 Gbps. The frequency of the second clock signal CK2 may be twice (×2) the frequency of the first clock signal CK1 in the example embodiment illustrated in FIG. 11A.

In each of the channel A and the channel B, each of the rising and falling edges of the second clock signal CK2 may be required twice during one period, and two second commands CMD2 may be required during one period. The translation circuit 130C may transmit four bits of data among eight pieces of bit data included in the first data signal A_DQ1 of the channel A in FIG. 11A to the channel A in sequence in accordance with the rising edge and falling edge of the second clock signal CK2. Also, the translation circuit 130C may transmit 4 bit data among 8 pieces of bit data included in the first data signal B_DQ1 of the channel B in FIG. 11A to the channel B in sequence in accordance with the rising edge and falling edge of the second clock signal CK2.

In a third example embodiment, the device under test 300C may be based on a PAM-3 interface, and the speed of the second signal may be 8 Gbaud. The frequency of the second clock signal CK2 may be twice (×2) the frequency of the first clock signal CK1 in the example embodiment illustrated in FIG. 11A.

In each of the channel A and the channel B, the rising and falling edges of the second clock signal CK2 may be required twice during one period, and two second commands CMD2 may be required during one period. The translation circuit 130C may translate 8 pieces of bit data included in the first data signal A_DQ1 of the channel A in FIG. 11A into PAM-3 symbols of 4 A channels. The PAM-3 symbols of 4 A channels may be transmitted to the channel A in sequence in accordance with the rising edge and falling edge of the second clock signal CK2.

Also, the translation circuit 130C may translate 8 pieces of bit data included in the first data signal B_DQ1 of the channel B in FIG. 11A into PAM-3 symbols of 4 channels B. The PAM-3 symbols of 4 channels B may be transmitted in sequence to the channel B in accordance with the rising edge and falling edge of the second clock signal CK2.

In the fourth example embodiment, the device under test 300C may be based on a PAM-3 interface, and the speed of the second signal may be 16 Gbaud. The frequency of the second clock signal CK2 may be four times (×4) the frequency of the first clock signal CK1 in the example embodiment illustrated in FIG. 9A.

The rising and falling edges of the second clock signal CK2 are required four times each during one period, and four second commands CMD2 may be required during one period. The translation circuit 130C may translate eight pieces of bit data included in the first data signal A_DQ1 of the channel A in FIG. 11A and eight pieces of bit data included in the first data signal B_DQ1 of the channel B into eight PAM-3 symbols. Eight PAM-3 symbols may be output similarly to the channel A and the channel B according to the rising edge and falling edge of the second clock signal CK2.

In an example embodiment, to write data in the device under test 300C, the data mapper/demapper 132C may combine pieces of bit data included in the first data signal A_DQ1 of the channel A and pieces of bit data included in the first data signal B_DQ1 of the channel B. The combined bit data may be transmitted to the decoder/encoder 134C.

In another example embodiment, when data is read from the device under test 300C, the data mapper/demapper 132C may divide the combined bit data into data for each of the channel A and the channel B. The divided bit data may be transmitted to the test device through the first data pins A_PDQ1 of the channel A and the first data pins B_PDQ1 of the channel B.

Comparing FIG. 6 with FIG. 10, the test system 1000C in an example embodiment in FIG. 10 may simultaneously test two channels of the device under test 300C using half of the first data signals of the test system 1000A in the example embodiment in FIG. 6. In other words, in the test system 1000C, the number of channels of the device under test which may be simultaneously tested may be expanded. However, in the case of the device under test having a signal speed of 32 Gpbs according to the PAM-3 method, a plurality of channels may be tested with the same second data signal, such that it may be difficult to combine various second data signals.

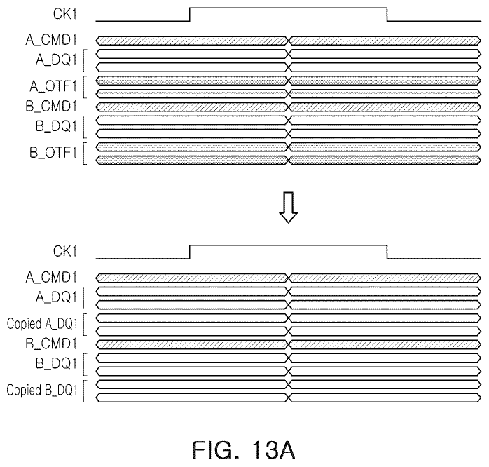

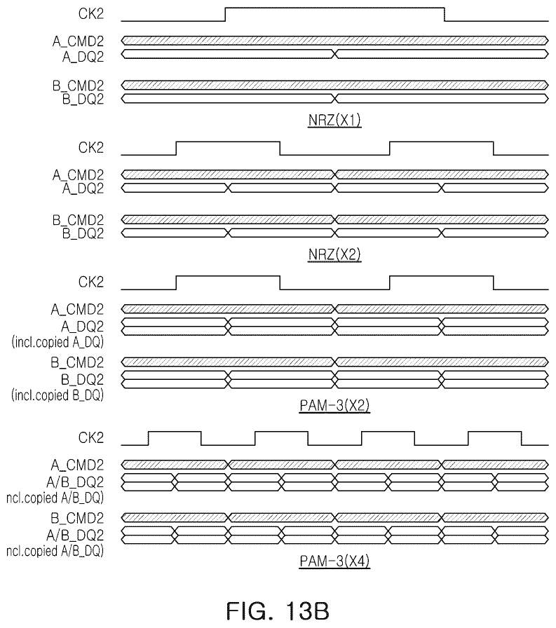

FIG. 12 is a diagram illustrating a test system according to an example embodiment. FIG. 13A is a diagram illustrating a first signal of a test system according to an example embodiment. FIG. 13B is a diagram illustrating a second signal of a test system according to an example embodiment.

First, referring to FIG. 12, a test system 1000D may include a translation device 100D, a test device 200D, and a device under test 300D. Specific example embodiments of the test system 1000D and the translation device 100D may be similar to the examples described above with reference to FIGS. 10, 11A, and 11B. Differences from the example embodiment illustrated in FIG. 10 will be described below.

In the example embodiment illustrated in FIG. 12, the test device 200D may transmit a first OTF signal A_OTF1 of a channel A to the translation device 100D through a first OTF pin A_POTF1 of a channel A, and may transmit a first OTF signal B_OTF1 of a channel B to the translation device 100D through a first OTF pin B_POTF1 of a channel B. The translation circuit 130D may further include a data signal copy 138D.

The data signal copy 138D may copy the first data signal A_DQ1 of the channel A transmitted through the first data pin A_PDQ1 of the channel A using the first OTF signal A_OTF1 of the channel A. Also, the data signal copy 138D may copy the first data signal B_DQ1 of the channel B transmitted through the first data pin B_PDQ1 of the channel B using the first OTF signal B_OTF1 of the channel B.

The first OTF signal A_OTF1 of the channel A may the same as or different from the first OTF signal B_OTF1 of the channel B. Specific example embodiments of the first OTF signal A_OTF1 and B_OTF1, and data signal copy 138D may be similar to the examples described above with reference to FIGS. 8 to 9B.

Comparing the translation circuit 130C in FIG. 10 with the translation circuit 130D in FIG. 12, there may be a difference in whether the entirety of pieces of bit data required to translate the method of the data signal are input from the test devices 200C and 200D. The translation circuit 130C in FIG. 10 may receive the entirety of pieces of bit data for the channel A required for the signal method translation through the first data pins A_PDQ1 of the channel A. Also, the translation circuit 130C in FIG. 10 may receive the entirety of pieces of bit data for the channel B required for the signal method translation through the first data pins B_PDQ1 of the channel B.

Differently from the above example, the translation circuit 130D in FIG. 11 may receive a portion of the pieces of bit data for the channel A through the first data pins A_PDQ1 of the channel A, and the other may be copied by the data signal copy 138D. Also, the translation circuit 130D in FIG. 11 may receive a portion of pieces of bit data for the channel B through the first data pins B_PDQ1 of the channel B, and the rest may be copied by the data signal copy 138D.

The translation device 100D in FIG. 12 may simultaneously test a plurality of channels of the device under test 300D using a portion of the first data pins A_PDQ1, B_PDQ1 of the channel A and the channel B. However, since the data signal is copied and the signal method is translated, tests for the entirety of possible data combinations may not be performed. Accordingly, accuracy of the test result may be reduced.

According to an example embodiment described with reference to FIG. 10 above, the test device 200D may be based on an NRZ interface, and the speed of the first signal according to the NRZ method may be 4 Gbps. The device under test 300D may be based on a PAM-3 interface, and the speed of the second signal according to the PAM-3 method may be 16 Gbaud. 256 pieces of bit data may be translated into 176 PAM-3 symbols. However, but an example embodiment thereof is not limited thereto.

In an example embodiment, the translation device 100D may transmit the second data signal DQ2 to, and receive the second data signal DQ2 from, the device under test 300D through the second channel. Since the translation device 100D may include 11 second channels, one second channel may transmit and receive 16 PAM-3 symbols. Accordingly, 8 rising and falling edges of the second clock signal CK2 may be required during one period.

Accordingly, the frequency of the second clock signal CK2 may be 8 times the frequency of the first clock signal CK1. The speed of the second clock signal CK2 may be a 4-fold multiplication of the speed of the first clock signal CK1. Accordingly, two rising and falling edges of the first clock signal CK1 may be required during one period.

In an example embodiment, the translation device 100D may transmit the first data signal A_DQ1 of the channel A to, and receive the first data signal A_DQ1 of the channel A from, the test device 200D through eight first channels, and may transmit the first data signal B_DQ1 of the channel B to, and receive the first data signal B_DQ1 of the channel B from, the test device 200D through eight first channels. In this case, the first data signal A_DQ1 of the channel A may include the 1-1 to 1-8 data signals A_DQ1-1 to A_DQ1-8 of the channel A, and the first data signal B_DQ1 of the channel B may include the 1-1 to 1-8 data signals B_DQ1-1 to B_DQ1-8 of the channel B.

During one period, one first channel may require 8 pieces of bit data. Accordingly, one first channel may include first data pins A_PDQ1 of two A channels or first data pins B_PDQ1 of two channels B.

The translation device 100D may include first OTF pins A_POTF1 of the A channel and first OTF pins B_POTF1 of the channel B. The first OTF signal A_OTF1 of the A channel and the first OTF signal B_OTF 1 of the channel B may be 2-bit signals. The first OTF signal A_OTF1 of the A channel may be applied to the first data signal A_DQ1 of the A channel, and the first OTF signal B_OTF1 of the channel B may be applied to the first data signal B_DQ1 of the channel B. For example, bit data included in the first data signal A_DQ1 of the A channel may be copied or inverted according to the first OTF signal A_OTF1 of the A channel. Bit data included in the first data signal B_DQ1 of the channel B may be copied or inverted according to the first OTF signal B_OTF1 of the channel B. However, the number of first OTF pins A_POTF1, B_POTF1 may not be limited thereto The translation device 100D may receive the first command/address signal A_CA1 of the channel A from the test device 200D through five first channels, and may receive the first command/address signal B_CA1 of the channel B from the test device 200D through five first channels. In this case, the first command/address signal A_CA1 of the channel A may include the 1-1 to 1-5 command/address signal A_CA1-1 to A_CA1-5 of the channel A. The first command/address signal B_CA1 of the channel B may include the 1-1 to 1-5 command/address signal B_CA1-1 to B_CA1-5 of the channel B.

During one period, one first channel may require five command/address signals. Accordingly, one first channel may include the first command/address pins A_PCA1 of five A channels or the first command/address pins B_PCA1 of five channels B.

FIG. 13A illustrates the first signal according to the NRZ method transmitted and received by the translation device 100D and the test device 200D. The first signal may include the first clock signal CK1, the first command/address signal A_CA1 of the channel A, the first data signal A_DQ1 of the channel A, the first command/address signal B_CA1 of the channel B, the first data signal B_DQ1 of the channel B, the first OTF signal A_OTF1 of the channel A, and the first OTF signal A_OFT1 of the channel B.

At each of the rising edge and falling edge of the first clock signal CK1 of the channel A, a first command/address signal A_CA1 of one A channel, a first data signal A_DQ1 of two A channels, and a first OTF signal A_OTF1 of two bits of the channel A may be transmitted. At each of the rising edge and falling edge of the first clock signal CK1 of the channel B, a first command/address signal B_CA1 of one channel B, a first data signal B_DQ1 of two channels B, and a first OTF signal B_OTF1 of two bits of the channel B may be transmitted.

At each of the rising edge and falling edge of the first clock signal CK1, the first data signal A_DQ1 of the two A channels may be copied once by the first OTF signal A_OTF1 of the channel A, and the first data signal B_DQ1 of the two channels B may be copied once by the first OTF signal B_OTF1 of the channel B, such that 4-bit data may be copied. For example, when the first OTF signals A_OTF1 and B_OTF1 are at a high level, the data signal is inverted, and the first OTF signals A_OTF1 and B_OTF1 are at a low level, the data signal may be copied equally. The translation device 100D may translate the first data signal A_DQ1 of the channel A, the first data signal B_DQ1 of the channel B, and the copied data signals of the channel A and the channel B into a signal according to the PAM-3 method FIG. 13B illustrates the second signal transmitted and received by the translation device 100C and the device under test 300C. The second signal may include a second clock signal CK2, a second command/address signal A_CA2 of the channel A, a second data signal A_DQ2 of the channel A, a second command/address signal B_CA2 of the channel B, and a second data signal B_DQ2 of the channel B. In this case, the second clock signal CK2 may be the same as the second clock signal A_CK2 of the channel A and the second clock signal B_CK2 of the channel B, and may be transmitted similarly to each of the channel A and channel B. During one period of the second clock signal CK2, one second command/address signal CMD2 (or CA2) may be transmitted and received in each of the channel A and channel B.

In an example embodiment, the device under test 300D may be based on NRZ and PAM-3 interfaces. The test device 200D may test both the device under test 300D based on NRZ interface and the device under test 300D based on PAM-3 interface. Hereinafter, the second signals according to the interface and the speed of the second signal of the device under test 300D will be described with reference to the second signals illustrated in FIG. 13B in order.

In a first example embodiment, the device under test 300D may be based on NRZ interface, and the speed of the second signal may be 4 Gbps. The frequency of the second clock signal CK2 may be the same (×1) as the frequency of the first clock signal CK1 in the example embodiment illustrated in FIG. 13A.

During one period, each of the rising and falling edges of the second clock signal CK2 are required once, and one second command CMD2 may be required during one period. The translation circuit 130D may output two bits of data among the four pieces of bit data included in the first data signal A_DQ1 of the channel A in FIG. 13A to the channel A in sequence in accordance with the rising edge and falling edge of the second clock signal CK2. Also, the translation circuit 130D may transmit two bits of data among the four pieces of bit data included in the first data signal B_DQ1 of the channel B in FIG. 13A to the channel B in sequence in accordance with the rising edge and falling edge of the second clock signal CK2.

In a second example embodiment, the device under test 300D may be based on an NRZ interface, and the speed of the second signal may be 8 Gbps. The frequency of the second clock signal CK2 may be twice (×2) the frequency of the first clock signal CK1 in the example embodiment illustrated in FIG. 13A.

In each of the channel A and the channel B, each of the rising and falling edges of the second clock signal CK2 may be required twice during one period, and two second commands CMD2 may be required during one period. The translation circuit 130D may transmit four bits of data included in the first data signal A_DQ1 of the channel A in FIG. 13A to the channel A in sequence in accordance with the rising edge and falling edge of the second clock signal CK2. Also, the translation circuit 130D may transmit four bits of data included in the first data signal B_DQ1 of the channel B in FIG. 13A to the channel B in sequence in accordance with the rising edge and falling edge of the second clock signal CK2

In a third example embodiment, the device under test 300B may be based on a PAM-3 interface, and the speed of the second signal may be 8 Gbaud. The frequency of the second clock signal CK2 may be twice (×2) the frequency of the first clock signal CK1 in the example embodiment illustrated in FIG. 9A.

The rising and falling edges of the second clock signal CK2 may be required twice each during one period, and two second commands CMD2 may be required during one period. The translation circuit 130D may translate four pieces of bit data included in the first data signal A_DQ1 of the channel A in FIG. 13A and four pieces of bit data included in the first data signal (copied A_DQ1) of the copied A channel into four PAM-3 symbols of the channel A. The four PAM-3 symbols of the channel A may be sequentially output to the channel A in accordance with the rising edge and falling edge of the second clock signal CK2.

Also, the translation circuit 130D may translate the four pieces of bit data included in the first data signal B_DQ1 of the channel B in FIG. 13A and the four pieces of bit data included in the first data signal (copied B_DQ1) of the copied channel B into the four PAM-3 symbols of the channel B. The four PAM-3 symbols of the channel B may be output to the channel B in sequence in accordance with the rising edge and falling edge of the second clock signal CK2.

In the fourth example embodiment, the device under test 300D may be based on the PAM-3 interface, and the speed of the second signal may be 16 Gbaud. The frequency of the second clock signal CK2 may be four times (×4) the frequency of the first clock signal CK1 in the example embodiment illustrated in FIG. 13A.

Each of the rising and falling edges of the second clock signal CK2 are required four times during one period, and four second commands CMD2 may be required during one period. The translation circuit 130D may translate into eight PAM-3 symbols by combining four pieces of bit data included in the first data signal A_DQ1 of the channel A in FIG. 13A, four pieces of bit data included in the copied first data signal (copied A_DQ1) of the channel A, four pieces of bit data included in the first data signal B_DQ1 of the channel B, and four pieces of bit data included in the copied first data signal (copied B_DQ1) of the channel B. Eight PAM-3 symbols may be output similarly to the channel A and channel B according to the rising and falling edges of the second clock signal CK2.

Comparing FIG. 6 with FIG. 12, the test system 1000D in an example embodiment in FIG. 12 may simultaneously test two channels of the device under test 300D using ¼ of the first data signals of the test system 1000A in an example embodiment in FIG. 6. In other words, in the test system 1000D, the number of channels of the device under test which may be simultaneously tested may be expanded. However, in the case of the device under test having a signal speed of 16 Gbaud according to the PAM-3 method, the plurality of channels may be tested with the same second data signal, such that it may be difficult to combine various second data signals.

According to the aforementioned example embodiments, a translation device may support testing of a memory device by translating different signal methods and signal speeds between a test device and a memory device. Accordingly, the memory device may be tested using an existing test device, thereby reducing the cost of building a test infrastructure.

While the example embodiments have been illustrated and described above, it will be configured as apparent to those skilled in the art that modifications and variations could be made without departing from the scope of the present disclosure as defined by the appended claims.

What is claimed is:

1. A translation device, comprising:
a first input/output circuit configured to transmit and receive a first signal having a first signal speed modulated based on a non-return to zero (NRZ) method through a plurality of first pins;
a second input/output circuit configured to transmit and receive a second signal having a second signal speed modulated based on a pulse amplitude modulation-3 (PAM-3) method through a plurality of second pins; and
a translation circuit configured to translate the first signal to the second signal or translate the second signal to the first signal,
wherein the second signal speed is equal to or greater than the first signal speed.

2. The translation device of claim 1,
wherein the first signal includes a first clock signal, a first command/address signal, and a first data signal,
wherein the plurality of first pins include a first clock pin, a plurality of first command/address pins, and a plurality of first data pins,
wherein the first clock signal is received through the first clock pin, the first command/address signal is received through the plurality of first command/address pins, and the first data signal is transmitted and received through the plurality of first data pins, and
wherein a number of the first command/address pins is less than a number of the first data pins.

3. The translation device of claim 2,
wherein the second signal includes a second clock signal, a second command/address signal, and a second data signal,
wherein the plurality of second pins includes a second clock pin, a second command/address pin, and a second data pin, and
wherein the second clock signal is transmitted through the second clock pin, the second command/address signal is transmitted through the second command/address pin, and the second data signal is transmitted and received through the second data pin.

4. The translation device of claim 3, wherein a number of the plurality of first pins is greater than a number of the plurality of second pins.

5. The translation device of claim 3, further comprising:
a phase locked loop (PLL) circuit configured to multiply and output the first clock signal and the second clock signal,
wherein the translation circuit is configured to translate the first signal having the first signal speed into the second signal having the second signal speed, or the second signal having the second signal speed into the first signal having the first signal speed.

6. The translation device of claim 5, further comprising:
a mode register configured to store information about the first signal speed, the second signal speed, the number of the plurality of first pins, and the number of the plurality of second pins; and
a command generator configured to output the first command/address signal as the second command/address signal according to a multiplied first clock signal.

7. The translation device of claim 5, wherein the translation circuit is configured to translate at least two bits of the first signal into at least one symbol of the second signal, and translate at least one symbol among a plurality of symbols of the second signal into at least two bits of the first signal.

8. The translation device of claim 7, wherein the translation circuit is configured to translate 11 bits of the first signal into 7 symbols of the second signal, and 7 symbols of the second signal into 11 bits of the first signal.

9. A translation device, comprising:
a first input/output circuit configured to transmit and receive a first signal having a first signal speed modulated based on a NRZ method, the first signal including a first clock signal, a first command/address signal, and a first data signal;
a second input/output circuit configured to transmit and receive a second signal having a second signal speed modulated based on a PAM-3 method, the second signal including a second clock signal, a second command/address signal, and a second data signal;
a phase locked loop (PLL) circuit configured to multiply the first clock signal and output the multiplied first clock signal;
a command generator configured to output the first command/address signal as the second command/address signal according to the multiplied first clock signal; and
a translation circuit configured to translate the first data signal to the second data signal or to translate the second signal to the first signal,
wherein the second signal speed is equal to or greater than the first signal speed, and
wherein the translation circuit is configured to translate at least two bits among a plurality of bits included in the first data signal to at least one symbol included in the second data signal, or translate at least one symbol among a plurality of symbols of the second signal to at least two bits of the first signal.

10. The translation device of claim 9, wherein the first signal further includes a first on the fly (OTF) signal.

11. The translation device of claim 10, wherein the translation circuit is configured to: copy the first data signal using the first OTF signal and generate a copied first data signal, and combine the first data signal and the copied first data signal and translate a combined signal into the second data signal.

12. The translation device of claim 11, wherein the translation circuit is configured to translate the second data signal to the first data signal and the copied first data signal.

13. The translation device of claim 10,
wherein the first command/address signal includes a 1-1 command/address signal, and a 1-2 command/address signal different from the 1-1 command/address signal, and
wherein the first data signal includes a 1-1 data signal and a 1-2 data signal different from the 1-1 data signal.

14. The translation device of claim 13, wherein the translation circuit is configured to: combine the 1-1 command/address signal and the 1-2 command/address signal and translate a combined signal to a second command/address signal, and combine the 1-1 data signal and the 1-2 data signal and translate the combined signal to a second data signal.

15. The translation device of claim 14, wherein the translation circuit is configured to: translate the second command/address signal to the 1-1 command/address signal and the 1-2 command/address signal, and translate the second data signal to the 1-1 data signal and the 1-2 data signal.

16. The translation device of claim 13, wherein the first signal further includes the first OTF signal and a second OTF signal.

17. The translation device of claim 16, wherein the translation circuit is configured to: copy the 1-1 data signal using the first OTF signal and generate a copied 1-1 data signal, and copy the 1-2 data signal using the second OTF signal and generate a copied 1-2 data signal.

18. The translation device of claim 17, wherein the translation circuit is configured to: combine the 1-1 data signal, the 1-2 data signal, the copied 1-1 data signal, and the copied 1-2 data signal, and translate a combined signal to the second data signal.

19. A translation device, comprising:
a first input/output circuit configured to transmit and receive a first clock signal, a first command/address signal, and a first data signal, wherein each of the first clock signal, the first command/address signal and the first data signal is a signal having a first signal speed modulated based on a NRZ method through a plurality of first pins;
a second input/output circuit configured to transmit and receive a second clock signal, a second command/address signal, and a second data signal, wherein each of the second clock signal, the second command/address signal, and the second data signal is a signal having a second signal speed modulated based on a PAM-3 method through a plurality of second pins;
a translation circuit configured to translate the first data signal to the second data signal, or translate the second data signal to the first data signal;
a PLL circuit configured to multiply and output the first clock signal having the first signal speed;
a command generator configured to output the first command/address signal as the second command/address signal according to a multiplied first clock signal;
a mode register configured to store information about the first signal speed and the second signal speed;
a first training circuit configured to control an input time of at least one of: the first data signal, the first clock signal, or the first command/address signal; and
a second training circuit configured to control an input time of at least one of: the second data signal, the second clock signal, or the second command/address signal.

20. The translation device of claim 19, further comprising:
a comparator configured to compare a signal obtained by translating the first data signal to the second signal speed by the translation circuit with a signal before translating the first data signal to the first signal speed by the translation circuit.
